(19) United States
(12) Patent Application Publication
(10) Pub. No.: US 2010/0189857 A1
(43) Pub. Date: Jul. 29, 2010

(54) AERATED FOOD PRODUCT AND PROCESS FOR PREPARING IT

(76) Inventors: Theodorus Berend Jan Blijdenstein, Vlaardingen (NL); Jian Cao, Shanghai (CN); Petrus Wilhelmus N de Groot, Vlaardingen (NL); Weichang Liu, Shanghai (CN); Simeon Dobrev Stoyanov, Vlaardingen (NL); Weizheng Zhou, Shanghai (CN)

Correspondence Address: UNILEVER PATENT GROUP, 800 SYLVAN AVENUE, AG West S. Wing, ENGLEWOOD CLIFFS, NJ, 07632-3100, US

(21) Appl. No.: 12/445,579

(22) PCT Filed: Sep. 13, 2007
(86) PCT No.: PCT/EP07/59658

§ 371 Date: Apr. 15, 2009

(30) Foreign Application Priority Data
Oct. 17, 2006 (EP) 06122405.1
Jun. 19, 2007 (EP) 07110536.5

(51) Int. Cl. A23L 1/03; A23L 1/308; A23L 1/24; A23L 1/39; A23P 1/16; A23L 1/0534; A23L 1/0522; A23C 13/12; A23L 2/02; A23L 2/54

(52) U.S. Cl. 426/329; 426/564

(57) ABSTRACT

There is provided an aerated food product in the form of a stable foam, comprising 5-80 vol. % gas bubbles, 15-90 wt. % water and 0.01 to 10 wt. % fibres, assembled with surface-active particles at the air-water interface due to attractive interaction between the surface-active particles and the fibres. Also provided is a process for preparing said foam.

### FIELD OF THE INVENTION

The invention relates to an aerated food product and a process for preparing it. More in particular, it relates to an edible food product in the form of a stable foam, as well as to a process for preparing it.

### BACKGROUND TO THE INVENTION

Aerated food products in the form of foams are well known. They comprise gas bubbles, usually air, nitrogen, carbon dioxide or nitrous oxide, whereby the bubbles are dispersed in the product and stabilised by means of an emulsifier or surfactant and/or a stabiliser.

Aerated food products typically fall into one of four groups: hot, ambient, chilled or frozen. The term “food” generally includes beverages, so hot food products such as cappuccino coffee are also included. Ambient aerated food products include whipped cream, marshmallows and bakery products, e.g. bread. Chilled aerated food products include whipped cream, mousses and beverages such as beer, milk shakes and smoothies. Frozen aerated food products include frozen confections such as ice cream, milk ice, frozen yoghurt, sherbet, slushes, frozen custard, water ice, sorbet, granitas and frozen purees.

Typically, aerated food products are unstable over a period of time in excess of a few days, because the gas bubbles tend to grow and the foam will collapse, unless the continuous phase of the product is gelled (e.g. mousse).

There are a number of mechanisms that degrade the quality of an aerated food product: Disproportionation and coalescence lead to bubble growth, changing product properties, such as its texture and physical appearance. Creaming leads to vertical phase separation in the container due to the buoyancy of the air bubbles, resulting in an increase of the number of bubbles close to the upper surface and depletion of bubbles at the bottom. There are aerated food products where creaming is desirable, e.g. the foam on the surface of beer. However, for aerated products requiring a foam life-time beyond a few minutes or hours, creaming leads to an undesirable appearance. It can also lead to subsequent air loss due to the closer packing of the bubbles in the foam and the foam collapse that may result there from.

There are several types of additives that are included in aerated food products to assist in the creation and maintenance of foam. These include surface active agents (surfactants) and stabilizers or thickeners. Surfactants include emulsifiers and proteins, which assist foam formation and inhibit coalescence and delay disproportionation. Stabilizers or thickeners such as gums can decrease or stop creaming. Carrageenans, guar gum, locust bean gum, pectins, alginates, xanthan, gellan, gelatin and mixtures thereof are examples of thickeners.

### Surface Active Agents

A surface-active agent or surfactant is a substance that lowers the surface tension of the medium in which it is dissolved, and/or the interfacial tension with other phases. Accordingly, it is positively adsorbed at the liquid/gas and/or at other interfaces.

Surface-active agents are widely used industry, for instance in foods, cleaning compositions and personal care products. In foods, they are used to achieve emulsions of oily and water-phases, such as in fat spreads or mayonnaise or foam formation and stabilisation of gas into products such as ice cream, whipped creams, mousses, shakes, bread etc. In laundry cleaning applications, they are used to solubilise dirt and keep it in solution, so that it can be effectively removed from the fabric.

In foods, surface-active materials are commonly used to prepare emulsions. Edible emulsions are used as a base for many types of food products. Mayonnaise compositions, for example, comprise edible oil-in-water emulsions that typically contain between 80 to 85% by weight oil, and egg yolk, salt, vinegar and water. The oil present in the edible emulsions used in such food products is generally present as droplets dispersed in the water phase, which are stabilised against coalescence by means of egg yolk proteins that act as surface active agents.

The surface-active agents that are most commonly used in food applications comprise low molecular weight emulsifiers that are primarily based on fatty acid derivatives. Examples include: lecithins, monoglycerides (saturated and unsaturated), polysorbate esters (Tweens), sorbitan esters (Spans), polyglycerol esters, propylene glycol monostearate, sodium and calcium stearoyl lactylates, sucrose esters, organic acids (lactic, acetic, tartaric, succinic) and esters of monoglycerides. Proteins and other surface-active biopolymers can also be used for this purpose. Examples of food proteins include milk proteins (caseins and whey proteins), soy protein, egg protein, lupin protein, pea protein, wheat protein. Other surface-active biopolymers include gum Arabic, sugar beet pectin, modified surface active pectin, hydroxypropylcellulose and OSA modified starch.

Typical surface active agents like proteins and emulsifiers or fats that are used for stabilisation of aerated food products may provide very satisfactory short term foam stability (period of hours to days), but are not very good at providing longer term foam stability, i.e. for a period of weeks or months. The latter is mainly limited by the disproportionation process, where gas diffuses form small to big bubbles, which leads to foam coarsening and eventually to complete loss of air. This problem can be partly avoided by gelling the continuous phase, but in many cases this leads to undesirable textural changes.

### Colloidal Particles as Surface Active Agents

Recently, the interest in the study of solid particles as emulsifiers for dispersed systems has been re-awakened. Much of this activity has been stimulated by the research of Binks and co-workers (Binks, B. P. Curr. Opin. Colloid Interface Sci. 2002, 7, 21), though the principles of such stabilisation were observed more than 100 years ago (Ramsden, W. Proc. R. Soc. London 1903, 72, 156).

Whilst the use of particles to stabilise o/w, w/o and duplex emulsions has been described, much less research has been carried out on particle stabilised foams.

### Shape Anisotropic Particles as Surface Active Agents

The majority of recent research on surface active colloidal particles has focussed on very low aspect ratio (spherical) particles. Only recently Alargova et al. have demonstrated (Langmuir, 2006, 22, 765-774) that high aspect ratio particles, such as epoxy resin polymeric rods, can be used to provide interfacial stabilisation to emulsions and foams. They show that particles could have an excellent foaming and foam stabilisation capacity if they have the right contact angle and high aspect ratio. The method for producing these polymeric rods has been outlined in WO-A-06/007393 (North Carolina State University), which discloses a process for preparing micro-rods using liquid-liquid solvent attrition in presence of external shear.

The disadvantage of the above method is that once made, these anisotropic particles have fixed properties, which might be not always suitable for the specific formulation and applications. There remains a need for more flexible methods of foam stabilisation, especially in edible food compositions. The aerated food product should be stable for at least some hours or preferably some days at room temperature. Preferably, the product is stable for at least several hours at higher temperature (higher than 20 degrees) and can survive the supply chain from the factory to the consumer without significant trouble. Preferably, the aerated food product has a pleasant mouth feel. More preferably, the aerated food product stabilisation mechanism can be prepared from conventional and relatively cheap materials.

The earlier, not pre-published International Patent Application PCT/EP2006/011382 (Unilever) discloses a surface-active material that comprises fibres which have been modified so as to impart surface-active properties onto said fibres and giving it a contact angle between 60° and 120°, wherein the fibres have an aspect ratio of more than 10 to 1,000. The modification of the fibres can be achieved by chemical or physical means. The chemical modification involves esterification or etherification, by means of hydrophobic groups, such like stearate and ethoxy groups, using well-known techniques. The physical modification includes coating of the fibres with hydrophobic materials, for example ethylcellulose or hydroxypropyl-cellulose. The surface-active materials can be used for foam and emulsion formation and stabilisation, coatings, encapsulation and drug delivery.

Surprisingly, we have found that we can solve this problem by using the principle of particle self-assembly between two types of particles (i) fibres and (ii) surface active particles, which then can self assemble when mixed together due to attractive interaction between them. These attractions are naturally occurring between the particles due to their intrinsic material properties or can be tuned by modifying one or both particles so that they can attract each other and self assemble.

Moreover, it was found that if one or both type of particles already gives good foamability and stability by themselves, the combined system comprising self assembled particle aggregates has superior foam ability and stability, when compared to the individual components.

The advantage of the finding outlined above is that it is now possible to dose both types of particles independently which allows to change the properties of the self-assembled surface active material at will at the point of use.

The present inventors have found that by using a simple foaming procedure it is possible to obtain an aerated product according to the invention, in the form of a very stable foam, comprising gas or air bubbles and fibres, self-assembled with surface-active particles at the air-water interface due to attractive interaction between the surface-active particles and the fibres.

### SUMMARY OF THE INVENTION

According to a first aspect, the invention provides an aerated product in the form of a stable foam, comprising 5-80 vol. % gas bubbles, 15-90 wt. % water and 0.001 to 10 wt. % fibres, assembled with surface-active particles at the air-water interface due to attractive interaction between the surface-active particles and the fibres.

According to a second aspect, there is provided a process for preparing said aerated product.

In a third aspect, the invention relates to an aerated food product obtainable by the process of the invention.

In a fourth aspect, the invention relates to a process for the preparation of a stabilised aerated food product, comprising the step of adding further ingredients to the aerated food product.

### DETAILED DESCRIPTION OF THE INVENTION

In its first aspect, the invention relates to an aerated food product in the form of a stable foam, comprising gas bubbles and fibres, self-assembled with surface-active particles at the air-water interface due to attractive interaction between the surface-active particles and the fibres.

The present invention requires the presence gas bubbles in the food composition, in an amount of at least about 5 vol. % and less than 80 vol. %. The gas suitably is air, but nitrogen or a gas comprising air and or nitrogen is also preferred. Other gasses that may be used instead of or in combination with air and/or nitrogen are e.g. carbon dioxide, nitrous oxide and oxygen. However, preferably the gas in the food composition is air, nitrogen or a combination thereof.

The term “aerated” means that gas has been intentionally incorporated into the product, such as by mechanical means. The extent of aeration is typically defined in terms of “overrun”. In the context of the present invention, % overrun is defined in volume terms as: ((volume of the final aerated product−volume of the mix)/volume of the mix)×100. The amount of overrun present in the product will vary depending on the desired product characteristics. For example, the level of overrun in ice cream is typically from about 70 to 100%, and in confectionery such as mousses the overrun can be as high as 200 to 250 wt %, whereas the overrun in water ices is from 25 to 30%. The level of overrun in some chilled products, ambient products and hot products can be lower, but generally over 10%, e.g. the level of overrun in milkshakes is typically from 10 to 40 wt %.

The present invention requires the presence of fibres. By the word “fibre”, we mean any insoluble, particulate structure, wherein the ratio between the length and the diameter ranges from 5 to infinite. “Insoluble” here means insoluble in water. Here, the diameter means the largest distance of the cross-section. Length and diameter are intended to mean the average length and diameter, as can be determined by (electron) microscopic analysis, atomic force microscopy or light-scattering.

The fibres used in the present invention have a length of preferably 0.1 to 100 micrometer, more preferably from 1 to 50 micrometer. Therefore, in a preferred aspect, the invention relates to a food composition wherein the length of the fibres is at least 0.1 μm and less than 100 μm. The diameter of the fibres is preferably in the range of 0.01 to 10 micrometer.

The aspect ratio (length/diameter) is preferably more than 10, more preferably more than 20 up to 1,000. Therefore, in a preferred aspect, the in invention relates to a food composition, wherein the fibre particles have an aspect ratio of at least 10, and less than 1000.

The materials of the “fibre” substance can be organic, inorganic, polymeric and macromolecular. The fibre topology might be linear or branched (star-like). The aspect ratio in this case is defined as aspect ratio of the longest branch.

The amount of the fibres in the aerated food composition is preferably between 0.001 and 10 wt. %, based on the total weight of the aerated composition, more preferably from 0.01 to 5 wt. %, especially from 0.1 to 1 wt. %. Therefore, in a preferred aspect, the invention relates to an aerated food composition, wherein fibres are present in an amount of at least 0.001 wt. % and less than 10 wt. %.

The fibres have to be of food-grade quality. The fibres may be of organic or inorganic origin. In particular, insoluble fibres made of carbohydrates, such as microcrystalline cellulose, can be used. One example of a suitable source is the microcrystalline cellulose (MCC) obtainable from Acetobacter. Other examples are citrus fibres, onion fibres, fibre particles made of wheat bran, of lignin and stearic acid fibres. Commercially available MCC is often coated with anti caking agent. For the present invention preferably pure MCC fibres are used. If so desired this can be prepared from commercially available MCC by removing the anti caking agent. Examples of inorganic fibres are CaCO₃ and attapulgite, but other edible inorganic crystals with fibre-like morphology could also be used.

Preferably, the fibres are vegetable fibres. Therefore, in a preferred aspect, the invention relates to an aerated food composition wherein the fibres are vegetable fibres. In another preferred aspect, the invention relates to an aerated food composition wherein the fibres comprise cellulose fibres or microcrystalline cellulose fibres.

Alternatively, the fibres can be made of a waxy material. Examples of a suitable source for the waxy material are the food-grade waxes carnauba wax, shellac wax or bee wax. This food-grade waxy material can be transformed into micro-particulate fibres by inducing precipitation of a wax solution via solvent change under shear. For instance, the food-grade waxy material is dissolved in high concentration in ethanol and a small amount of this solution is added to a viscous liquid medium and subjected to shearing. This procedure results in the emulsification of the wax solution in the viscous medium and shear driven elongation of the emulsion droplets. Successively, the wax solidifies into rod-like particles due to the escape of ethanol into the continuous liquid medium, which is assisted by the fact that ethanol is soluble in the liquid medium, while the waxy material is not or poorly soluble therein. After the fibres have been formed they can be extracted and purified by using the natural buoyancy of the wax. In order to facilitate this process the viscosity of continuous liquid phase should be decreased. The inclusion of water effectively thins the solution so that the rods will rise much quicker and a clear separation is seen between the rods and most of the solution. The liquid phase can then be taken and replaced by water several times in order to remove all solvents other than water. Due the fact that waxy materials have a contact angle at the air-water interface between 60° and 120°, the micro particulate fibres have affinity for adsorbing at the air/water surface.

The contact angle can be measured using the gel-trapping technique as described by technique as described by Paunov (Langmuir, 2003, 19, 7970-7976) or alternatively by using commercial contact angle measurement apparatus, such as the Dataphysics OCA20.

The parameters that affect the formation of the waxy fibres, are a.o. the viscosity and the composition of continuous liquid phase, the shear rate, the initial droplet size, the wax concentration into ethanol solution and the total solution volume. Of these, the parameters with noticeable affects were changes to the stirring media and to the concentration of wax in ethanol. Changes to the standard solvent ratio resulted in greater or less shear which had a limited effect on the size of the rods produced. A larger influence is held by the type of solvent used. The inclusion of a small amount of ethanol to the viscous stirring media resulted in shorter but better defined micro rods with much lower flaking. It is thought that the inclusion of ethanol in the stirring media may slow the rate of precipitation of waxy material resulting in smaller micro emulsion droplets, thus giving shorter micro rods. For the influence of the various parameters that affect the formation of the waxy fibres, reference is made to WO-A-06/007393 (North Carolina State University).

The present invention further requires the presence of surface active particles. The expression “surface active” means that the particles are preferentially present at an air-water interface compared with the bulk of the water phase. The presence of particles at an interface can be determined by (electron-) microscopic analysis.

The surface active particles will accumulate at the interface due to their wetting properties which is determined by the tree phase contact angle θ between particle/phase 1 (continuous phase where particles are dispersed) and second phase 2 creating the interface with phase 1. In this case the surface activity, expressed as a desorption energy (E_{des}) is a function of the particle size, R, the surface tension, γ, between phase 1 and 2 and particle contact angle, θ, which for the case of spherical particles is

ΔE_{des}=πR²γ(1±cos θ)²

From this formula follows that the maximum desorption energy is obtained at a contact angle of 90°. Simple estimation shows that even for very small nanometer size particles and for typical values of surface/interfacial tension the maximum of this energy could exceed values of 1000 kT, where k is the Boltzmann constant and T is ambient thermodynamic temperature of the system measured in Kelvin. As a result, the advantage of particle stabilisation is that it is almost impossible to displace an adsorbed particle once adsorbed to an interface. This gives excellent stability to particle-stabilised emulsions and foams, especially with respect to ripening mechanisms such as disproportionation.

Preferably, the surface-active particles have a volume weighted mean diameter in the range of 0.01 to 10 μm, preferably in the range of 0.1 to 1 μm. Therefore, in a preferred aspect, the present invention relates to an aerated food composition wherein the volume weighted mean diameter of the surface active particles is at least 0.01 μm and less than 10 μm. In another preferred aspect, the invention relates to a food composition, wherein two times the volume weighted mean diameter of the surface active particle is smaller than the length of the fibres. More preferably, the mean diameter is four times smaller than the length.

The amount of the surface active particles in the aerated food composition is preferably between 0.001 and 10 wt. %, based on the total weight of the aerated composition, more preferably from 0.01 to 5 wt. %, especially from 0.1 to 1 wt. %. Therefore, in a preferred aspect, the invention relates to a food composition, wherein the surface active particles are present in an amount of at least 0.001 wt. % and less than 10 wt. %.

The contact angle of the surface-active particles is between 60° and 120°, preferably between 70° and 110°, more preferably between 80° and 100°.

The surface active particles as used in the present invention are food-grade. Preferably, the surface-active particles are organic particles that are preferably made from materials selected from the group consisting of modified celluloses, modified starches and insoluble proteins. For example, modified starch granules can be used, e.g. Dry Flo PC® ex National Starch, Bridgewater, N.J., USA. As protein, globular proteins such as soy, pea and/or dairy protein can be used. Information on globular proteins is given in Food Science, Nutrition and Health 5th ed, Brian Fox and Allan Cameron, (1989), publisher Edward Arnold. The protein can be insolubilized to obtain discrete protein particles e.g. by heat treatment and/or treatment with acid. The protein preferably has a Protein Dispersibility Index (PDI) at 20° C. of less than about 20, more preferably less than about 10%. Generally, it is preferred to have the PDI as low as reasonably possible. PDI can be measured according to the method AOCS Ba 10-65 (99) at 20° C.

In a preferred embodiment, the surface-active particles are made from methyl or ethyl cellulose. If methyl cellulose is used, it should be ensured that it can occur as particles, i.e. that it is insoluble, e.g. by choosing a methyl cellulose with a high degree of substitution.

Alternatively, the surface-active particles can be inorganic. For example, silicon dioxide or food grade clays can be used, e.g. bentonite. If so desired the surface activity of particles can be modified by chemical or physical techniques known per se, e.g. by attaching small groups, for example alkyl groups such as ethyl or methyl groups.

The surface active-particles in the aerated food products of the invention are assembled with the fibres at the air-water interface, due to attractive interaction between the surface-active particles and the fibres.

### Particle Self-Assembly

For the properties and behaviour of colloidal particles dispersions, the interaction forces between two particles play in important role. Depending on the interplay between these forces colloidal dispersion could be stable or unstable. In between the realm of stable and unstable dispersions is the area of self-assembly, which is defined as the ability of particles to spontaneously self-associate into new structures, which is mainly caused by interparticle forces and requires a fine balance between attractive and repulsive forces. Obviously, if these forces are always repulsive then dispersions will be very stable and the particles will not self assemble. If these forces are always attractive, dispersions will become unstable and they will flocculate and sediment. The same principle applies for the total strength of the forces: If the interactions are too weak (much less then kT) then thermal fluctuations will disrupt the self assembled structures. If the interactions are too strong (much larger then kT) then self-assembled structures form irreversibly and grow bigger and bigger. This leads to destabilization of the dispersion, flocculation and precipitation. Particle self assembly may also be reversible or irreversible, equilibrium or non equilibrium, i.e. self assembled structures are kinetically trapped into a meta-stable state.

In the process of self-assembly, the components must be able to move with respect to each other. Their steady-state positions balance mutual attractive and repulsive interaction forces. Some of the most well-know forces are:
Electrostatic Interaction: Colloidal particles often carry an electrical charge and therefore attract or repel each other. The charge of both the continuous and the dispersed phase, as well as the mobility of the phases are factors affecting this interaction.
Van der Waals forces: This is due to interaction between two dipoles which are either permanent or induced. Even if the particles don't have a permanent dipole, fluctuations of the electron density give rise to a temporary dipole in a particle. This temporary dipole induces a dipole in particles nearby. The temporary dipole and the induced dipoles are then attracted to each other. This is known as van der Waals force and is always present, is short range and usually is attractive.

The combination of electrostatic and van der Waals forces are usually referred as DLVO forces, while the rest of the forces are referred as non-DLVO forces. Some of the best known non-DLVO forces are:
Excluded Volume Repulsion: forces which prevent any overlap between hard particles.
Steric forces between polymer-covered surfaces or in solutions containing non-adsorbing polymer can modulate interparticle forces, producing an additional repulsive steric stabilization force or an attractive depletion force between them.
Short range forces due to Hydrogen Bonding: Molecules comprising electronegative atoms (O, N, F, Cl) with an H-atom attached can form exceptionally strong, through short range (0.1-0.17 nm) and directional bonds, according to X—H . . . Y, where X denotes the mother molecule and Y denotes the linked molecule. This type of bond explains structural properties of water/ice, protein folding and DNA-double helix formation. Due to their very short range interactions due to hydrogen bonds sometimes are referred as sticky interactions.
Forces due to the Hydrophobic Interactions: If one attempts to disperse hydrophobic particles or molecules in water, it is more energy efficient for the particles to stick together and to minimize the area having contact with water. This attraction is caused by strong hydrogen mediated water-water-interactions, repelling molecules that disturb the water structure formation. The range of this interaction is in the range of few nanometers.

Depending on the interplay between these forces, a colloidal dispersion may be stable, meta stable or unstable. In order to trap a dispersion of particles in a meta-stable state, allowing self-assemble, one can use a number of methods:
Reducing the electrostatic barrier that prevents aggregation of the particles. This can be accomplished by the addition of salt to a suspension or changing the pH of a suspension to effectively neutralize or “screen” the surface charge of the particles in suspension. This diminishes the repulsive forces that keep colloidal particles separate and allows for coagulation due to van der Waals forces.
Addition of a charged polymer flocculant. Polymer flocculants can bridge individual colloidal particles by attractive electrostatic interactions. For example, negatively charged colloidal silica particles can be flocculated by the addition of a positively charged polymer.
Addition of nonadsorbed polymers called depletants that cause aggregation due to entropic effects.

In the self-assembly of larger components (meso- or macroscopic objects) the interaction can often be selected and tailored and can include (besides the interactions mentioned above) gravitational attraction, external electromagnetic fields, capillary and entropic interactions, which are not important in the case of single molecules (Whitesides and Grzybowski, Science, 295, 2002). Deformation forces such as shear and elongation can also be used to promote self-assembly.

As described above, the properties of the fibres and the surface active particles are chosen such that the mutual attractive interaction either occurs naturally (i.e. it is an intrinsic property of both particles and fibre, for instance they can form H-bond) or is enabled in order to promote self-assembly of the fibres with the surface active particles by carefully adjusting the forces acting between the particles and the fibres. This can be achieved without difficulty by a person skilled in the areas of (physical) chemistry, physics, colloid science, material science or nano technology.

For example, when the fibres are made slightly hydrophobic, they can naturally self-assemble with hydrophobic particles due to presence of short range hydrophobic interaction. In this case it is important that strong and long range electrostatic or steric repulsions are decreased, otherwise the fibres and particles cannot come into close proximity and self-assemble.

Self-assembly can occur on two different levels, depending on the properties of fibres: In the case of non surface active fibres we can have a lower level of self assembly between surface active (hydrophobic) particles and hydrophilic fibres, leading to aggregates with amphiphilic properties in the bulk and a second higher level of self assembly at the gas/liquid interface which occurs at the point of gas entrapment (aeration). Surface active particles or complexes between them and fibres will adsorb first, while enriching the interface. This in turn will lead to the consecutive interfacial attachment and self assembly, due the attractive interaction with the remaining fibres. Depending on its size, a single fibre can bridge several particles and therefore the fibres can collectively act as a scaffold for the whole interface. If both fibres and particles are surface active, and still can self-assemble, one can expect both of them to adsorb at the interface and self assemble-predominantly there, forming a network of adsorbed fibres and surface active particles, which can act as a glue between the rods. Obviously, in this case the structure will be highly dependent on the relative size and concentration of each of the two components.

The self-assembly between the fibres and the particles can be observed by looking at the resulting self-assembled structures in the bulk or at the gas/liquid interface by means of microscopic techniques, preferably by means of Scanning Electron Microscopy (SEM). The presence can also be detected by means of light microscopy, where bubbles with wrinkled surfaces at the air/water interface are observed.

The present food composition comprises amounts of fibres and surface active particles in a weight ratio of preferably between 1:10 and 10:1, more preferably between 1:5 and 5:1, especially between 1:3 and 3:1.

A second aspect of the present invention is a process for preparing an aerated product in the form of a stable foam, comprising the steps of:
(a) preparing an aqueous dispersion comprising surface-active particles,
(b) adding fibres to said dispersion in the form of a dry powder or an aqueous dispersion,
(c) incorporating air into and homogenising the obtained mixture, whereby the fibres assemble with the surface-active particles in situ at the air-water interface, due to attractive interaction between the surface-active particles and the fibres to form a stable foam.

In a third aspect, the invention relates to an aerated food product obtainable by the process of the invention.

In a fourth aspect, the invention relates to a process for the preparation of a stabilised aerated food product, comprising the step of adding further ingredients to the aerated food product, to obtain a food product selected from the group consisting of aerated products such as fruit smoothies, coffee creamers, drinkable meals, mayonnaises, salad dressings, mousses, sauces, soups and drinks. The aerated food product is stable over a very long time (weeks or even months), where the stabilisation is achieved by interfacial stabilisation due to self-assembled fibers and surface active particles at gas/liquid interfaces of the bubbles.

The invention will now be further illustrated by means of the following non-limiting examples.

### DESCRIPTION OF THE FIGURES

FIG. 1 is an optical microscopy image of foam produced by MCC-EC complex of Example 1

FIG. 2 shows a graph of the foam stability in the first 30 minutes

FIG. 3 shows a graph of the foam stability over a period of 20 days

FIG. 4 shows a transmission electron microscope image of an air bubble stabilized by MCC-EC complex. The scale bar is 2 micron.

FIG. 5 shows a field emission scanning electron microscope image of dry foam produced by MCC-EC complex.

FIG. 6 is a field emission scanning electron microscope image of the external surface of the dry foam produced by MCC-EC complex, showing the fibres and the surface active particles.

FIG. 7 shows SEM images of functional CaCO3 rods (left) and modified mica (right)

FIG. 8 shows a light microscope image of air bubbles stabilised by CaCO3 rods and modified mica.

FIG. 9 shows a microscopic image of air bubbles in the whipped MCC-EC-foam containing 1 wt % EC and 1 wt % MCC. The bubble surface appears wrinkled, which is an indication of a strong elastic layer at the air/water interface composed of EC/MCC which provides the resistance against disproportionation

FIG. 10 shows a Microscopic Image of an Aerated Fruit Smoothie. The wrinkles on the bubble surface indicate the resistance of the bubble surface against shrinkage.

### EXAMPLE 1

### MCC-EC Complex Formed by In-Situ Interaction

Pure microcrystalline cellulose (MCC) fibre particles were prepared as follows: 15 g of medical absorbent cotton (Shanghai Medical Instrument Co. Ltd, China) was dispersed into 150 ml of 50% (V/V) sulfuric acid in a 400 ml beaker. Subsequently the beaker was put into a water bath with the temperature of 30° C. The hydrolysis will last for 6.5 hours with continuous magnetic stirring. The resultant mixture was cooled down and diluted by 850 ml of deionised water. After 24 hours, microcrystalline cellulose (MCC) fibres would settle down to the bottom of the beaker, and the supernatant was removed and replaced by the same volume of deionised water. This purification process was repeated for 5 times. Then the MCC suspension was transferred into a dialysis tube to remove the acid and impurities completely by dialyzing in water. This procedure was repeated for several times until the pH value of the water in the MCC dispersion was neutral (pH˜6). The MCC suspension was further diluted to 4% (weight concentration) and was put into a freeze dryer. The dry MCC powders were obtained after 48 hours and the yield is about 20%.

To measure the length L of the MCC fibre particles, a sample of the MCC powder was finely dispersed in water, centrifuged and separate fractions were dried and assessed with Scanning Electron Microscopy. The length L of the fibres of the recombined fractions was mostly in the range of 1-5 μm. The diameter dl of the MCC fibres was less than 100 nm and the aspect ratio of the fibres was larger than 10.

A dispersion containing 1 wt % surface-active particles (ethyl cellulose) and 1 wt % MCC fibre particles in water was prepared (step a) as follows: 1 g ethyl cellulose (“EC”, 100 cps, ethoxy content 48%, Aldrich) powder was dissolved in 100 ml acetone at 30° C. in a 500 ml beaker. An equal volume of deionised water was quickly added into the EC solution under strong stirring to precipitate the EC into particles. The acetone was removed with a rotary evaporator and water was added to set the final volume to 100 ml. The volume weighted mean diameter of the EC particles was 120 nm. It was measured using dynamic light scattering.

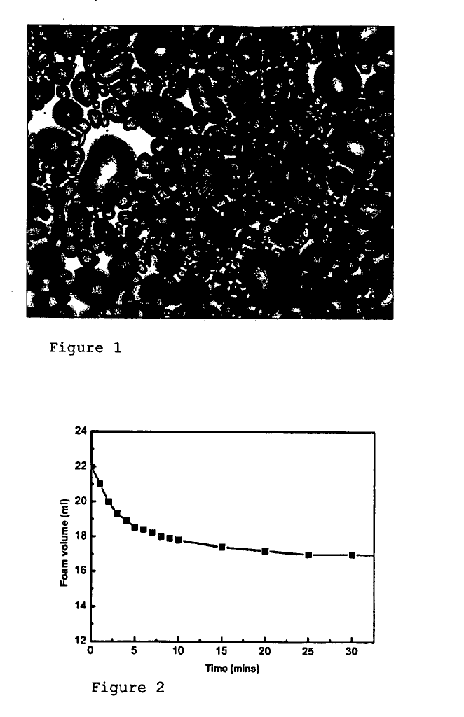

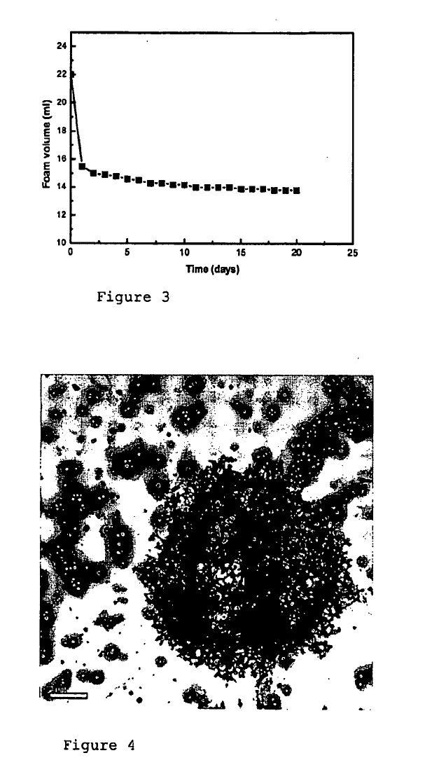

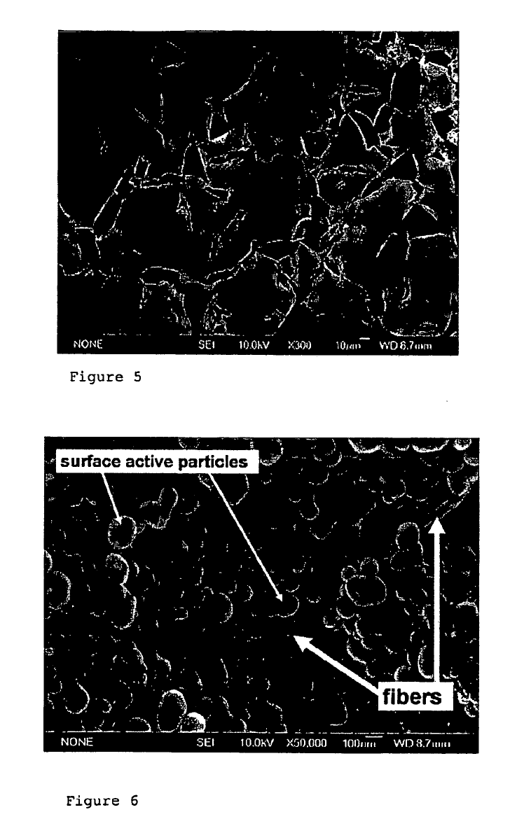

Finally, 1 g dry MCC powder prepared as described above was added into EC dispersion. The MCC-EC dispersion was stirred for 10 minutes, sonicated for 10 minutes and stirred for another 10 minutes. The resulting dispersion was transferred into a 25 ml cylinder and was shaken by hand for 30 s to produce foam. The overrun of the foam would reach 120% and the foam was stable for at least 3 months at ambient or chilled conditions. FIG. 1 shows an optical microscopy image of the foam produced by MCC-EC complex and FIGS. 2 and 3 illustrate the stability of the foam. FIG. 4 shows a transmission electron microscope, image of an air bubble stabilized by the MCC-EC complex and in FIG. 5 a field emission scanning electron microscope image is shown of dry foam produced by the MCC-EC complex. FIG. 6 shows a field emission scanning electron microscope image of the external surface of the dry foam produced by the MCC-EC complex. The arrows indicate the fibres and the surface active particles.

It is believed that the attraction between MCC and EC which enables their self-assembly arises from hydrogen bonding. This could be shown by adding 2M urea (which is known to disrupt formation of hydrogen bonds) into EC solution before the addition of MCC to the system. The systems containing 2M urea has a lower overrun and stability when compared to same system without urea. This demonstrates the importance of the interaction between surface active particles (EC) and fibers (MCC) and supports the hypothesis that H-bond formations is the reason for assembly.

### EXAMPLE 2

4.0 g mica (SCI-351, 10˜100 μm, Shanghai Zhuerna High-tech Powder Materials Co., Ltd. China) was dispersed in 40 ml acetone solution containing 0.2 g ethyl cellulose (EC, 10 cps, ethoxy content 48%, Aldrich). After 5 minutes sonication, 160 ml deionised water was quickly added into the dispersion under strong stirring. 5 minutes later, most of EC particles precipitated out from acetone and deposited onto the surface of mica. After filtration and aging in 80° C. vacuum oven for 4 hours, Mica was successfully modified by ethyl cellulose.

The modified mica showed good foamability and foam stability. 0.5 g modified mica was dispersed in 10 ml water containing 0.75 wt % ethanol, and then the dispersion was transferred to 25 ml cylinder. The overrun reached 25% after strong shaking by hand for 30 seconds. One week later, the foam still remained stable.

Functional CaCO₃ rods could be used to improve the foam ability and foam stability of modified mica. CaCO₃ rods (Qinghai Haixing Science & Technology Co., Ltd. China) were modified by oleoyl chloride to adjust their wettability from highly hydrophilic to intermediate hydrophobic. CaCO₃ rods were dried in 160° C. oven for 4 hours to remove adsorbed water. Acetone was also dried by 4A molecular sieve desiccant. 10 ml oleoyl chloride (85%, Aldrich) was diluted by 90 ml dried acetone to get 10% (V/V) oleoyl chloride solution. 5.0 g CaCO₃ rods was dispersed into 100 ml treated acetone. After 10 minutes sonication, 3.0 ml oleoyl chloride solution was dropped into the dispersion under stirring. 1 hour later, the dispersion was filtrated and washed three times by ethanol (Re-dispersing filter cake into 30 ml ethanol, stirring for 5 minutes). After washing, the filter cake was dispersed into 30 ml ethanol, and then 120 ml water was added into the dispersion under strong stirring. Half an hour later, the dispersion was filtrated and washed three times by water (Re-dispersing the cake into 60 ml water, stirring for 10 minutes). After washing and filtration; we weighed the filter cake and added certain water to get 50 wt % CaCO₃ slurry.

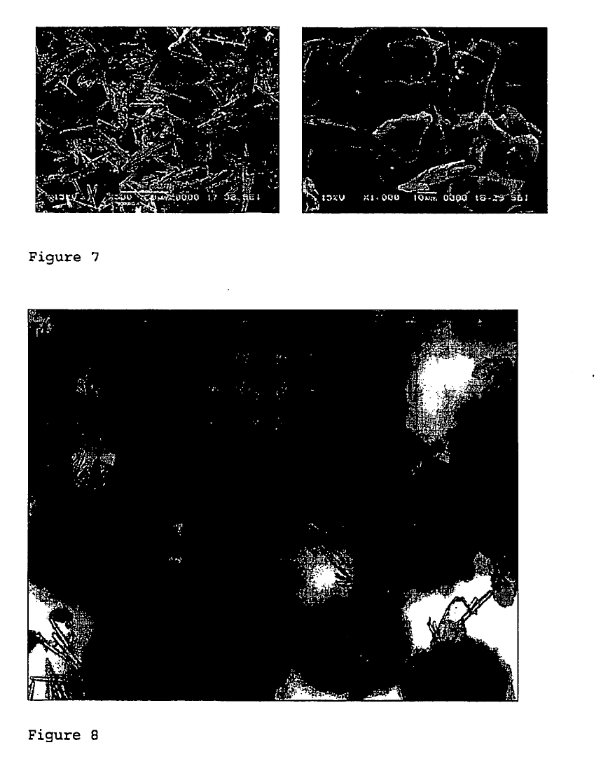

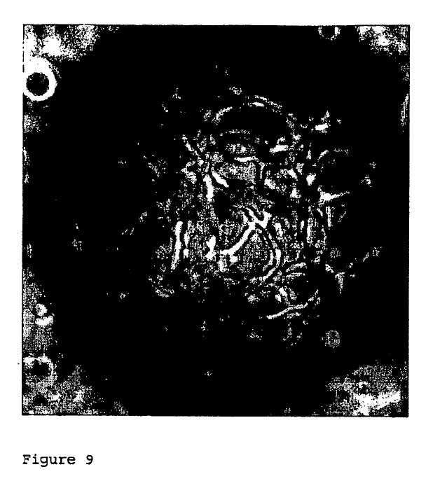

When we mixed 0.5 g modified mica and 1.0 g functional CaCO₃ slurry with 10 ml water containing 0.75 wt % ethanol, the overrun could reach 100% after strong shaking by hand for 30 seconds. The foam also showed much better foam stability than modified mica, and was stable for at least 2 months at ambient or chilled conditions. FIG. 7 shows SEM images of functional CaCO₃ rods (left) and modified mica (right) and FIG. 8 shows a light microscope image of air bubbles stabilised by CaCO₃ rods and modified mica.

### EXAMPLE 3

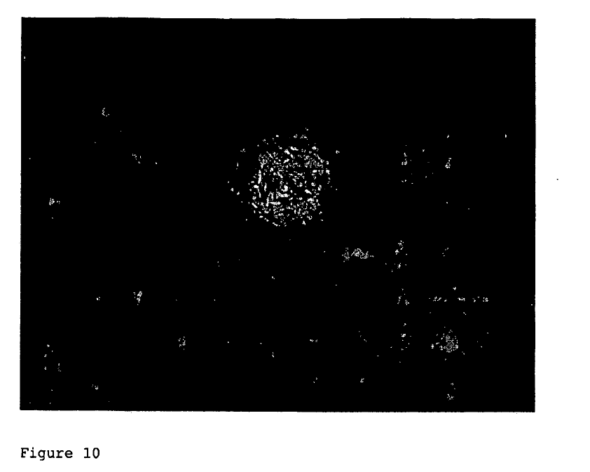

In the same way as described in Example 1, 200 ml dispersion containing 1% EC was prepared. Two grams of MCC, prepared according to the procedure described in example 1, was added as dry matter setting the MCC-concentration to 1%. This dispersion was then aerated by using a Kenwood kitchen mixer operating at maximum power for 2 minutes. This resulted in a total foam volume of approximately 2000 ml. The foam obtained concentrated by liquid drainage, in a similar manner as the foam obtained by shaking (see example 1). After one day the final air content of approximately 99% was reached. This concentrated foam was stable against disproportionation for at least 6 months at ambient or chilled conditions. FIG. 9 shows a microscopic image of air bubbles in the whipped MCC-EC-foam containing 1 wt % EC and 1 wt % MCC. The bubble surface appears wrinkled, which is an indication of a strong elastic layer at the air/water interface composed of EC/MCC which provides the resistance against disproportionation.

### EXAMPLE 4

An aerated fruit Smoothie was prepared by gently mixing 10 ml foam produced by MCC-EC dispersion (see example 3) into 10 ml of liquid. The liquid consisted for one half of Knorr Vie (Strawberry+carrot+apple) and for the other half of a 0.5 wt % xanthan solution, which was added to prevent liquid drainage from the foam. The mixing resulted in a prototype with a final gas content of about 50 Vol % (i.e. overrun about 100%) and a final xanthan concentration of 0.25 wt %. The aerated smoothie was stable against disproportionation for at least 3 weeks at ambient or chilled conditions. FIG. 10 shows a microscopic Image of the Aerated Fruit Smoothie. The wrinkles on the bubble surface indicate the resistance of the bubble surface against shrinkage.

### EXAMPLE 5

An aerated coffee creamer was prepared by gently mixing 10 ml foam produced by MCC-EC dispersion (see example 3) into 10 ml of liquid. The liquid consisted for one half of Becel® coffee creamer (Unilever, Netherlands) and for the other half of a 0.5 wt % solution of xanthan gum in water, which was added to prevent liquid drainage from the foam. The Becel® coffee creamer contained 78 wt % water, 4 wt % of vegetable oil, 0.7 wt % milk protein and 11 wt % milk sugar. The mixing resulted in a prototype with a final gas content of about 50 vol % and a final xanthan concentration of 0.25 wt %. The aerated coffee creamer was stable against disproportionation for at least 3 weeks at ambient and chilled conditions. The prototype product contained about 89 wt % water, 2 wt % fat, 3.5 wt % protein and 6 wt % carbohydrates.

### EXAMPLE 6

An aerated drinkable meal was prepared in the same way as the aerated coffee creamer described in example 5. Slim.Fast® milk shake (raspberry flavour, Unilever, UK) was used instead of the Becel® coffee creamer. The Slim.Fast® milk shake contained 85 wt % water, 2.0 wt % fat, 4.3 wt % protein and 7.7 wt % carbohydrates. The resulting prototype product had a gas content of about 50 vol %. It was stable and no disproportionation occurred for at least 3 weeks at ambient and chilled conditions.

### EXAMPLE 7

An aerated mayonnaise was prepared in the same way as the aerated coffee creamer described in example 5. Conventional mayonnaise was used instead of the Becel® coffee creamer. The aerated mayonnaise (overrun about 100%) was stable against disproportionation for at least 3 weeks at ambient or chilled conditions.

### EXAMPLE 8

An aerated salad dressing was prepared in the same way as the aerated coffee creamer described in example 5. Calvé® salad dressing (Unilever, Netherlands) was used instead of the Becel® coffee creamer. The salad dressing contained 70 wt % water, 21 wt % fat, 1 wt % protein and 7 wt % carbohydrates. The resulting aerated salad dressing had a gas content of about 50 vol % (i.e. overrun about 100%). It was stable and no disproportionation occurred for at least 3 weeks at ambient and chilled conditions

1. Aerated food product in the form of a stable foam, comprising 5-80 vol. % gas bubbles, 15-90 wt. % water and 0.001 to 10 wt. % fibres, assembled with surface-active particles at the air-water interface due to attractive interaction between the surface-active particles and the fibres.

2. Aerated food product according to claim 1, wherein the gas is air.

3. Aerated food product according to claim 1, wherein the fibres have a length of 0.1 to 100 micrometer, preferably from 1 to 10 micrometer.

4. Aerated food product according to claim 1, wherein the fibres are organic fibres.

5. Aerated food product according to claim 4, wherein the fibres are cellulose fibres, for example citrus fibres.

6. Aerated food product according to claim 5, wherein the fibres are microcrystalline cellulose.

7. Aerated food product according to claim 6, wherein the fibres are microcrystalline cellulose obtainable from Acetobacter.

8. Aerated food product according to claim 1 wherein the contact angle of surface-active particles is between 60° and 120°, preferably between 70° and 110°, more preferably between 80° and 100°.

9. Aerated food product according to claim 1, wherein the surface-active particles have a volume weighted mean diameter in the range of 0.01 to 10 μm, preferably in the range of 0.1 to 1 μm.

10. Aerated food product according to claim 1, wherein the surface-active particles are organic particles.

11. Aerated food product according to claim 10, wherein the surface-active particles are made from materials selected from the group consisting of modified celluloses, modified starches, proteins and mixtures thereof.

12. Aerated food product according to claim 11, wherein the surface-active particles are made from methyl or ethyl cellulose.

13. Aerated food product according to claim 1, wherein the surface-active particles are inorganic.

14. Aerated food product according to claim 13, wherein the surface-active particles are inorganic and modified to obtain a contact angle between 60° and 120°, preferably between 70° and 110°, more preferably between 80° and 100°.

15. Process for preparing an aerated food product in the form of a stable foam, comprising the steps of:
(a) preparing an aqueous dispersion comprising surface-active particles,
(b) adding fibres to said dispersion in the form of a dry powder or an aqueous dispersion,
(c) incorporating a gas into and homogenising the obtained mixture, whereby the fibres assemble with the surface-active particles in situ at the gas-water interface, due to attractive interaction between the surface-active particles and the fibres to form a stable foam.

16. Process according to claim 15, wherein the gas is air.

17. Process according to claim 1, wherein the fibres have a length of 0.1 to 100 micrometer, preferably from 1 to 10 micrometer.

18. Process according to claim 1, wherein the fibres are organic fibres.

19. Process according to claim 18, wherein the fibres are cellulose fibres, for example citrus fibres.

20. Process according to claim 19, wherein the fibres are microcrystalline cellulose.

21. Process according to claim 20, wherein the fibres are microcrystalline cellulose obtainable from Acetobacter.

22. Process according to claim 1, wherein the contact angle of surface-active particles is between 60° and 120°, preferably between 70° and 110°, more preferably between 80° and 100°.

23. Process according to claim 1, wherein the surface-active particles have a volume weighted mean diameter in the range of 0.01 to 10 μm, preferably in the range of 0.1 to 1 μm.

24. Process according to claim 1, wherein the surface-active particles are organic particles.

25. Process according to claim 1, wherein the surface-active particles are organic and modified to obtain a contact angle between 60° and 120°, preferably between 70° and 110°, more preferably between 80° and 100°.

26. Process according to claim 1, wherein the surface-active particles are selected from the group consisting of modified celluloses, modified starches, protein particles and mixtures thereof.

27. Process according to claim 26, wherein the surface-active particles are made from methyl or ethyl cellulose.

28. Process according to claim 1, wherein the surface-active particles are inorganic.

29. Aerated food product obtainable by the process of claim 1, comprising 10-80 vol. % gas bubbles, 15-90 wt. % water and 0.01 to 10 wt. % fibres, assembled with surface-active particles at the air-water interface due to attractive interaction between the surface-active particles and the fibres.

30. Food product according to claim 29, wherein the gas is air.

31. Process for the preparation of a stabilised food product, comprising the step of adding further ingredients to the aerated food product according to claim 1, to obtain a food product selected from the group consisting of foamed products such as fruit smoothies, coffee creamers, drinkable meals, mayonnaises, salad dressings, mousses, sauces, soups and drinks.
